(19) United States
(12) Patent Application Publication
(10) Pub. No.: US 2007/0257471 A1
(43) Pub. Date: Nov. 8, 2007

(54) Universal Infant Carrier Transport

(75) Inventors: Pete Jonathan Myers, Wheaton, IL (US); Eric Wang, Vancouver (CA)

Correspondence Address: MILLER, MATTHIAS & HULL, ONE NORTH FRANKLIN STREET, SUITE 2350, CHICAGO, IL, 60606, US

(73) Assignee: Baby Planet LLC, Des Plaines, IL (US)

(21) Appl. No.: 11/382,172

(22) Filed: May 8, 2006

(51) Int. Cl. B62B 7/00

(52) U.S. Cl. 280/642

(57) ABSTRACT

A universal infant carrier transport is disclosed. The infant carrier transport is adapted to hold and safely retain infant carriers of various dimensions and shapes. The carrier, which can be a tri-wheel type baby stroller having a handle for convenient pushing by the parent, includes a horizontal platform extending from the tri-wheeled stroller and adapted to receive and support the bottom of the infant carrier. A rotating roll bar is provided and is positionable so as to rotate over the infant carrier and lock in place. A ratcheting mechanism is provided in the mount between the roll bar and the bottom support so as to be lockably positioned into one of a plurality of different positions depending upon the width and height of the infant carrier. An easy push button release mechanism is provided so as to release the ratchet when it is desired to remove the infant carrier from the transport.

### FIELD OF THE DISCLOSURE

The present disclosure generally relates to infant carriers, car seats, and baby strollers and, more particularly, relates to wheeled transports adapted to receive and hold infant carriers of any shape and size.

### BACKGROUND OF THE DISCLOSURE

Infant carriers, car seats, and baby strollers have become ubiquitous products in modern day parenting. Not only are they convenient, but current U.S. regulations require children, when traveling in automobiles, to do so within federally approved car seats or child restraint systems up to a certain weight and age. With respect to infants, they are typically transported in infant carriers, portable seats which can lock into a base secured to the seat of the automobile by way of a seat belt. The infant carrier can be teleasably mounted in the base so that if the baby is asleep or otherwise comfortable the baby need not be removed from and disturbed, but the infant carrier itself can simply be disengaged from the base, removed from the vehicle, and carried as appropriate.

It has also become common place for such infant carriers to be manufactured so as to lock into a baby stroller as well. Again, as opposed to removing the child from the seat itself, which can be potentially problematic when the child is asleep or otherwise comfortable, the infant carrier and baby can be entirely removed from the vehicle without disturbing the child and the infant carrier can then be locked into the baby stroller for further transport.

While such systems are effective and quite popular; each manufacturer of such baby products often manufactures its infant carriers and strollers to unique dimensions and shapes and with specific locking geometry unique to each model and brand. Accordingly, if a parent wishes to remove an infant carrier from an automobile and mount the infant carrier into the stroller, the stroller typically has to be manufactured by the same entity as the infant carrier. Again, while this is effective, there are certainly times when it would be desirable for the infant carrier to be mounted in strollers which are not manufactured by the same entity. For example, this situation may apply when on vacation, when in a hurry, when in a store, or any other time when the parent does not have access to the stroller to which the infant carrier is uniquely fitted, or, most commonly, when the infant seat has been purchased without the accompanying stroller.

In light of this, attempts have been made to manufacture strollers which can accommodate infant carrier or car seats of many sizes. With such designs, regardless of the size or shape of the infant carrier or car seat, the stroller is purportedly manufactured to hold the car seat, infant carrier in place. For example, Worth, U.S. Pat. No. 6,302,412, discloses a folding stroller which purportedly allows for a car seat to be locked in place across a range of widths, lengths and other dimensions. However, it is also not truly universal in that it requires the particular car seat to mate with a cross bar of the folding stroller. More specifically, the car seat must include at least one indent adapted to mate with at least one tab extending from a cross bar of the stroller. In addition to the mating between the cross bar and the car seat, a flexible seat belt is also provided on the stroller which wraps around the car seat and is secured in place with first and second notches.

Another example is Wood, U.S. Pat. No. 6,641,164, which discloses a stroller or infant seat holder which purportedly is able to hold car seats or infant carriers of a wide range of dimensions. However, it too uses a combination of a rigid bar and a flexible strap or belt. More particularly, it uses what is referred to as a bumper bar across a back side of the infant carrier and a seat belt across the front portion of the infant carrier.

While such structures are effective, they are not necessarily convenient or easy to use. It would accordingly be an improvement in the art to provide a universal infant carrier transport adapted to hold an infant carrier of virtually any realistic dimension and size in a stroller with ease, simplicity, and safety.

### SUMMARY OF THE DISCLOSURE

In accordance with one aspect of the disclosure, universal infant carrier transport is disclosed which comprises a wheeled cart, a platform, and a toll bar. The platform extends from the wheeled cart and includes a central aperture adapted to receive a bottom surface of an infant carrier. The roll bar extends from the wheeled cart and is movable between the locked and unlocked positions. The roll bar holds the infant carrier between the platform and the roll bar when in the locked position.

In accordance with another aspect of the disclosure, a universal infant carrier transport is disclosed which comprises a wheeled cart, a platform, an infant carrier, and a roll bar. The platform extends from the wheeled cart as does the roll bar. The infant carrier nests within the platform and includes a handle by which the infant carrier is carried. The infant carrier further includes a bottom by which the infant carrier can be latched into a base strapped into an automobile seat. The roll bars are adapted to clamp the infant carrier between the platform and the roll bar. The roll bar is lockable into a plurality of positions relative to the platform.

In accordance with another aspect of the disclosure, a universal infant carrier transport is disclosed which comprises a wheeled cant, a platform, a roll bar, and a release mechanism. The wheeled cart includes a frame to which at least one wheel is mounted, while the platform extends from the frame and includes an aperture sized to receive the bottom of an infant carrier. The roll bar is rotatably mounted to the frame above the platform with a ratchet mechanism. The roll bar is freely movable between an upper unlocked position and a lower locked position. The ratchet mechanism prevents movement of the roll bar from the lower, locked position to the upper; unlocked position. The release mechanism is adapted to allow movement of the roll bat from the lower, locked position to the upper, unlocked position.

These and other aspects and features of the disclosure will become more readily apparent upon reading the following detailed description when taken into conjunction with the accompanying drawings.

### BRIEF DESCRIPTION OF THE DRAWINGS

FIG. 1 is a perspective view of a universal infant carrier transport constructed in accordance with the teachings of the present disclosure and shown without an infant carrier held therein;

FIG. 2 is a perspective view of the transport of FIG. 1 but with an infant carrier loaded therein and showing the transport unlocked;

FIG. 3 is a perspective view of the transport of FIG. 2 with an infant carrier loaded therein and showing the transport locked;

FIG. 4 is a side view of the transport of FIG. 1;

FIG. 5 is a side view of the transport of FIG. 2;

FIG. 6 is a side view of the transport of FIG. 3;

FIG. 7 is a front view of the transport of FIG. 1;

FIG. 8 is a top view of the transport of FIG. 1;

FIG. 9 is a rear view of the transport of FIG. 1;

FIG. 10 is a perspective view of the transport in a folded configuration;

FIG. 11 is a side view of the transport in the folded configuration;

FIG. 12 is a perspective view of the transport and showing the roll bat and ratchet mechanism in exploded view;

FIG. 13 is an enlarged perspective of the roll bar and ratchet mechanism in an exploded view; and

FIG. 14 is a top view of the ratchet of the roll bar and ratchet mechanism and an exploded view.

While the present disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the disclosure as defined by the appended claims.

### DETAILED DESCRIPTION OF THE DISCLOSURE

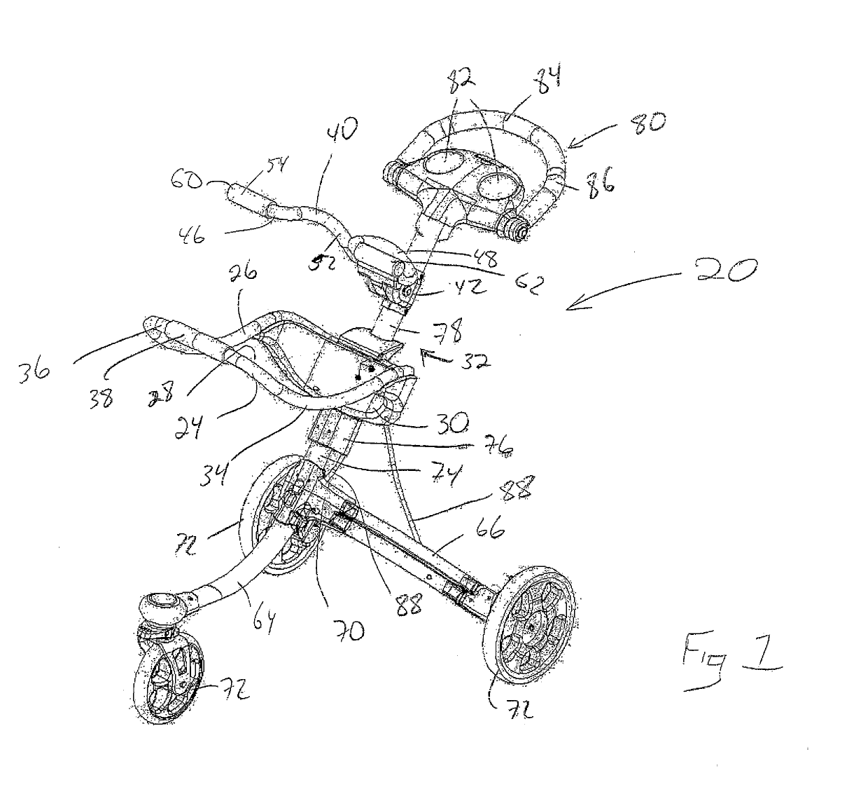

Referring now to the drawings and with specific reference to FIGS. 1-3, a universal infant carrier transport is depicted therein by reference numeral 20. As used herein, “infant carrier” is defined as the type of transport having a padded seat for a very small child (under one year of age or as detailed in the infant carrier use guidelines) and including a rotating handle by which the parent can carry the infant carrier. An infant carrier also typically mates with a base adapted to the strapped into an automobile seat with a standard seat belt. While the base will remain in the automobile, the infant carrier can be detached there from and carried away from the automobile. Such devices have become very popular in recent decades as they allow the patent to keep the baby within the seat and not disturb the child when the seat is carried or removed from the vehicle. This is to be differentiated from conventional child restraint systems more commonly known as “car seats” which are typically designed to remain strapped within the vehicle and are used after one year of age when the child is too large to be carried about in an infant carrier.

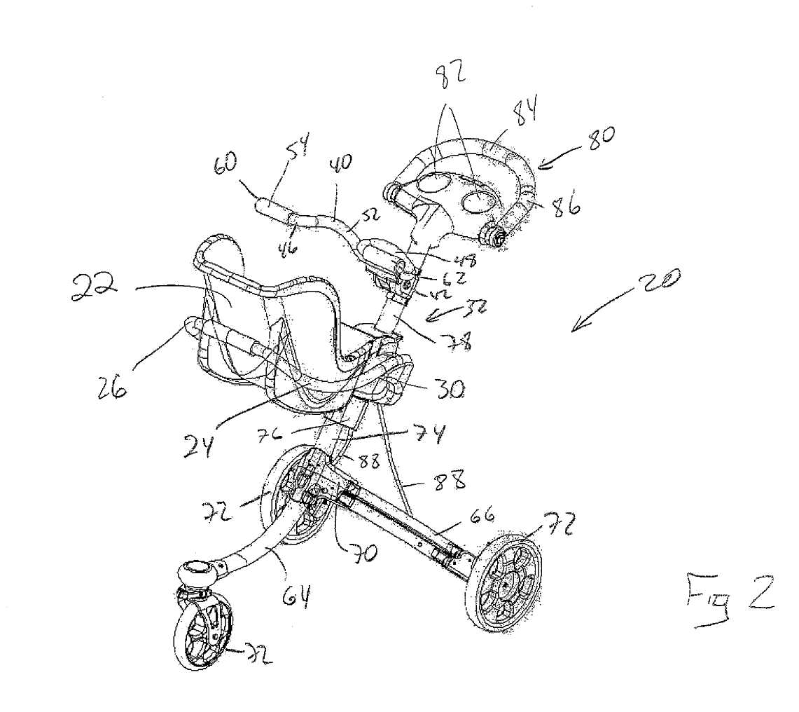

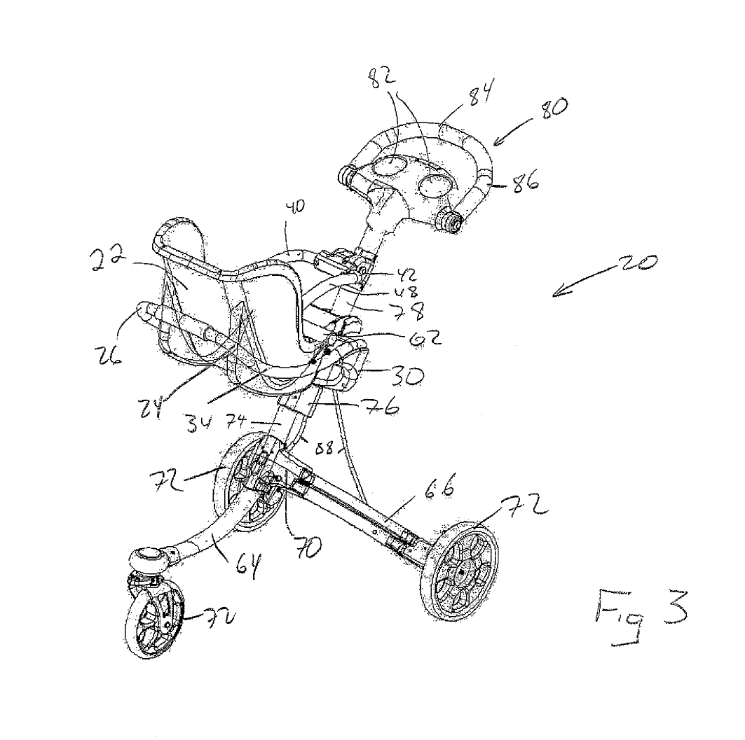

Referring again to FIGS. 1-3, the universal infant carrier transport is shown in FIG. 1 without an infant carrier loaded therein, while in FIG. 2 it does show an infant carrier 22 loaded therein. The difference between FIGS. 2 and 3 is that in FIG. 2 the infant carrier is not locked into the transport 20, whereas in FIG. 3 the infant carrier 22 is in fact locked into the transport 20.

In order to securely hold the infant carrier 22 into the transport, a combination of elements are employed. The elements to hold the infant carrier 22 to the transport 20 are designed so as to accommodate a wide variety of infant carrier sizes and shapes, and in all practicality, thereby receive practically all currently manufactured infant carriers 22. One of the elements used to the hold the infant carrier 22 is platform 24. As shown best in FIG. 1, the platform 24 may include rigid tubing or piping 26 forming a continuous loop with an aperture 28 therethrough. The platform 24 may further include a mounting structure 30 to allow for connection of the platform 24 to the transport frame 32 as more particularly described below. The tubing 26 may include curved sides 34 with a raised front end 36 so as to accommodate the general shape of the majority of infant carriers 22 on the market. In addition, such a shape will allow for the infant carrier 22 to be held in a horizontal disposition that is comfortable and safe for the child. The tubing 26 may further include padding 38 to allow for a certain degree of shock absorption and thus comfort for the child, as well as providing added traction or frictional grip between the tubing 26 and the infant carrier 22.

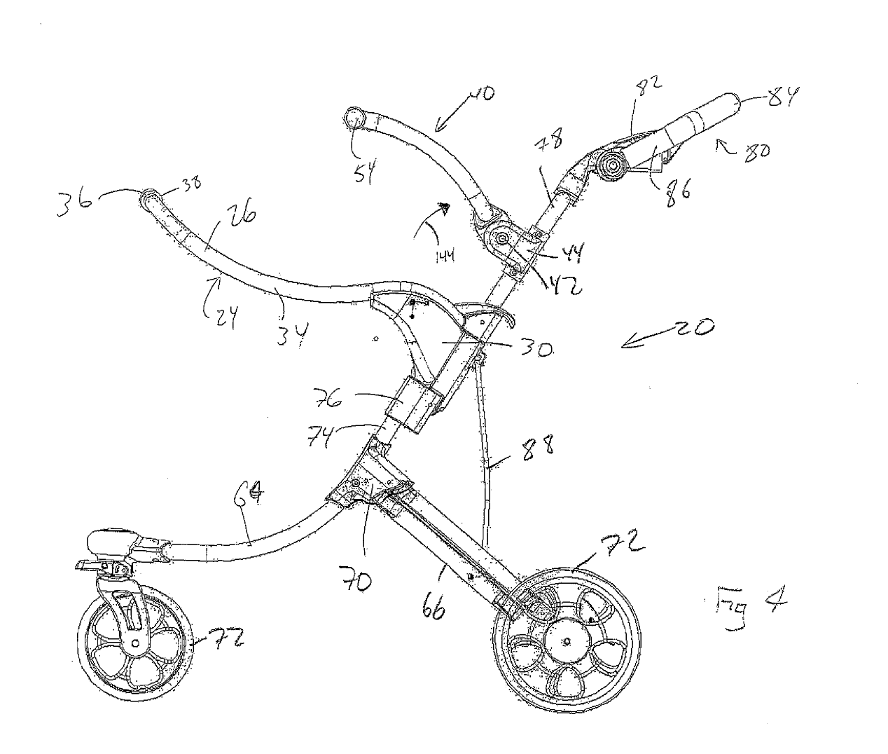

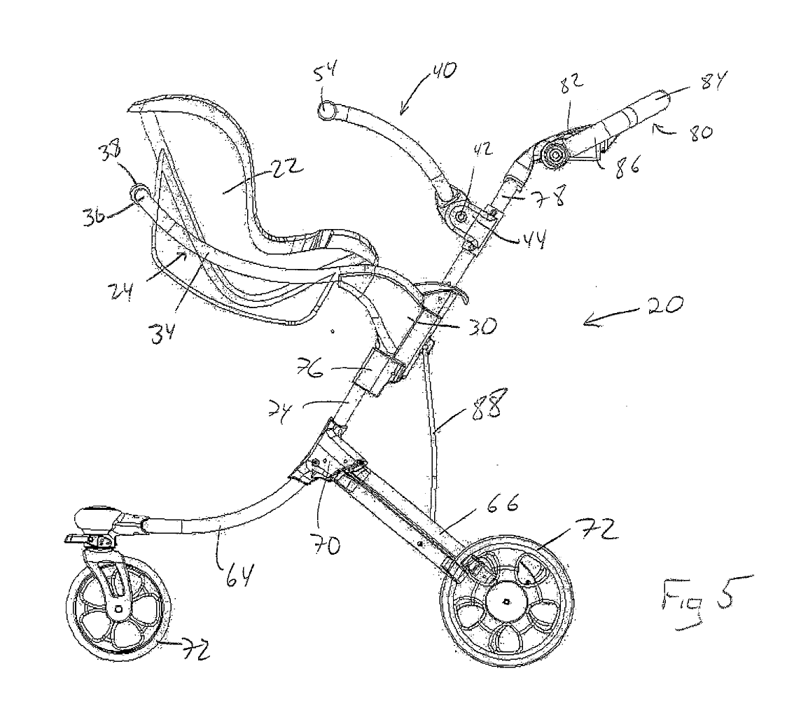

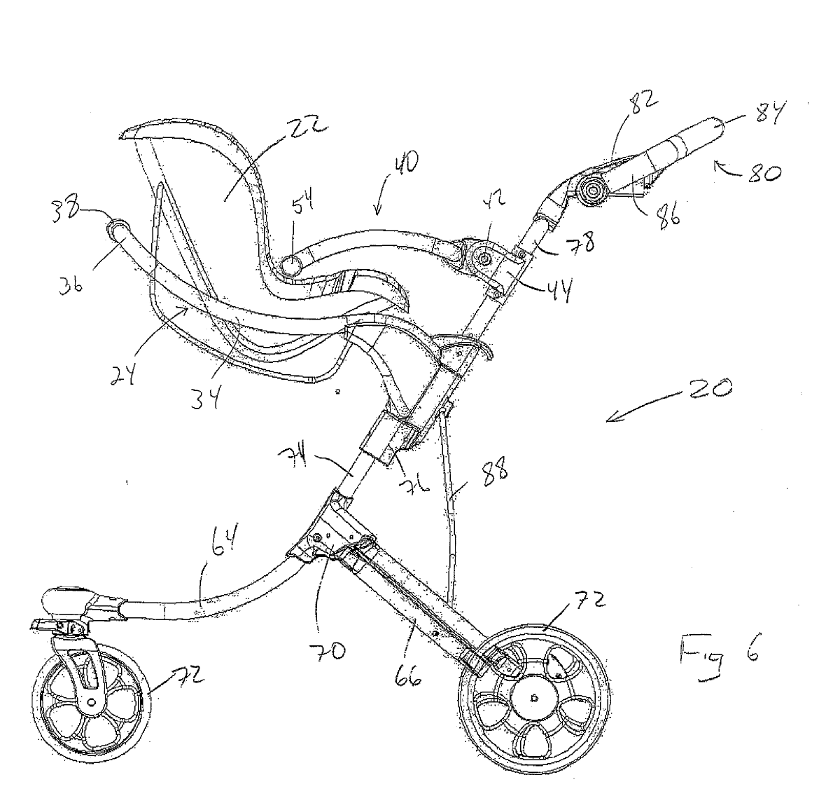

The second element used to secure the infant carrier 22 into the transport 20 is a toll bar 40. As will be noted best in a comparison between FIGS. 4, 5 and 6, the roll bar 40 is rotatably mounted to the frame 32 at pivot 42. Such a connection allows for the infant carrier 22 to be easily loaded into the platform 24 when the toll bar is pivoted away from the platform into the upward or unlocked position depicted in FIGS. 4 and 5 and then when the toll bar 40 is downwardly pivoted about pivot 42, the roll bar 40 engages the infant carrier 22 and clamps the infant carrier 22 between the platform 24 and the roll bar 40 as shown in FIG. 6.

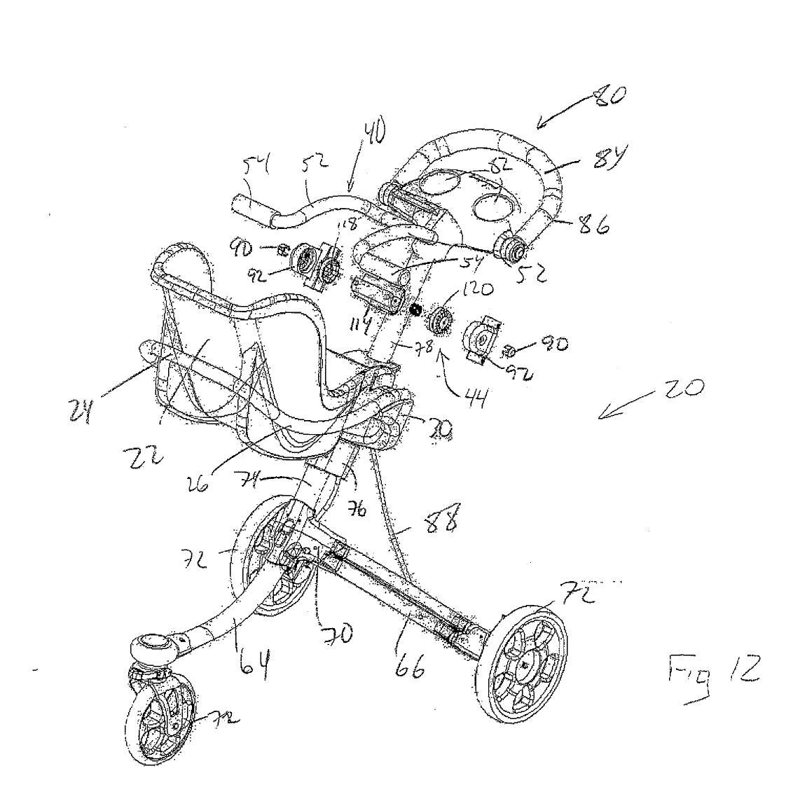

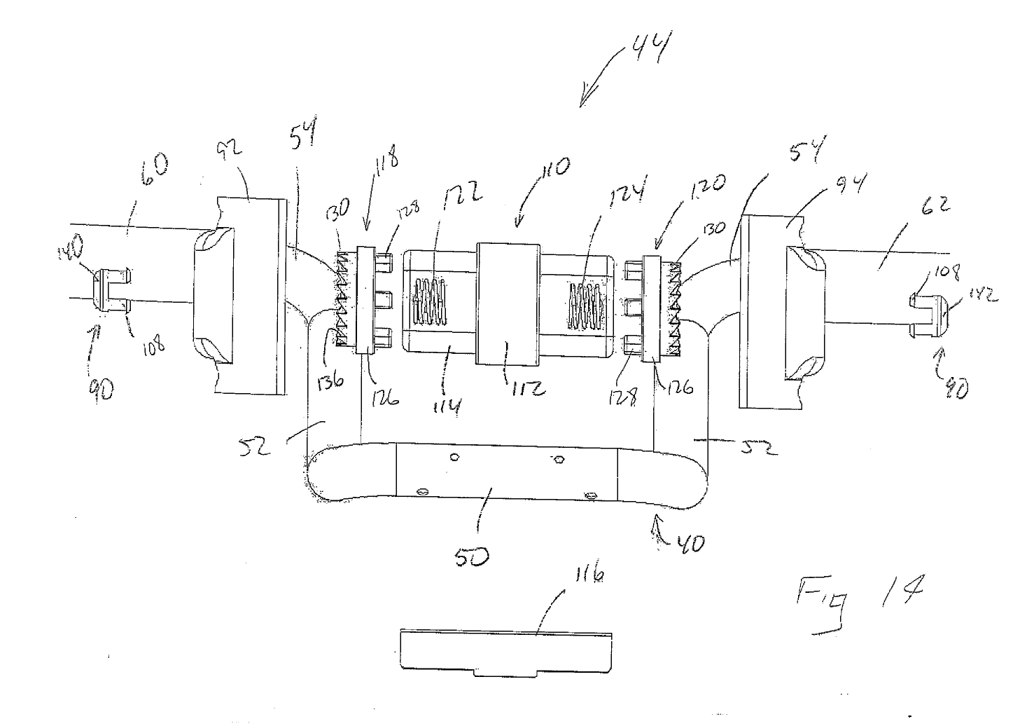

In older to also allow for a variety of shapes and sizes for infant carrier 22, the roll bat 40 is pivotally mounted to a frame 32 by way of a ratchet mechanism 44 (see FIGS. 12-14). The ratchet mechanism 443 which will be described in further detail herein, functions in much of the same manner that roll bars do in conjunction with amusement park rides, wherein a user enters a cart of a roller coaster; for example, with the roll bar raised, and then after the user sits, the toll bar moves downwardly in incremental fashion toward the user. The roll bar cannot be raised by the user, only the operator of the ride can do so, thereby, ensuring the safety of the user.

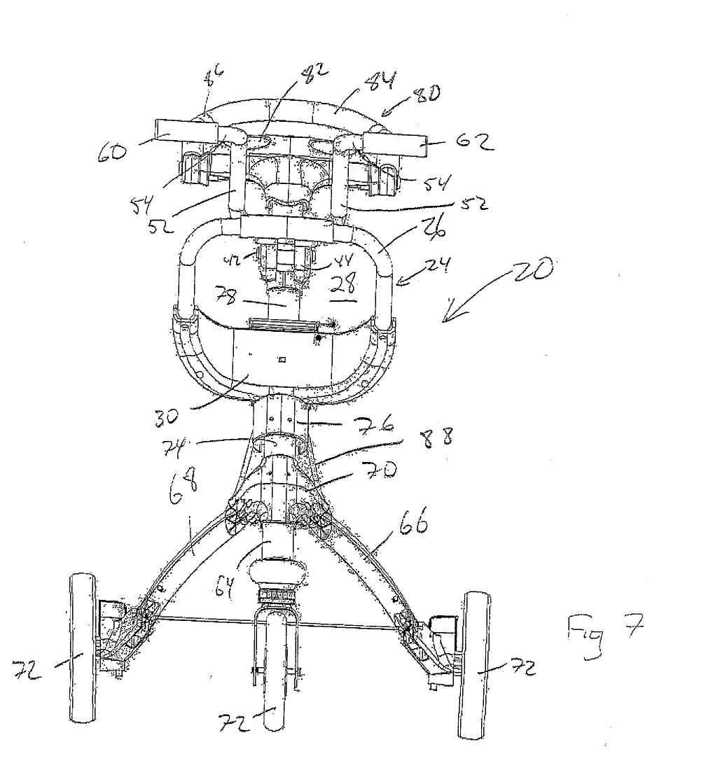

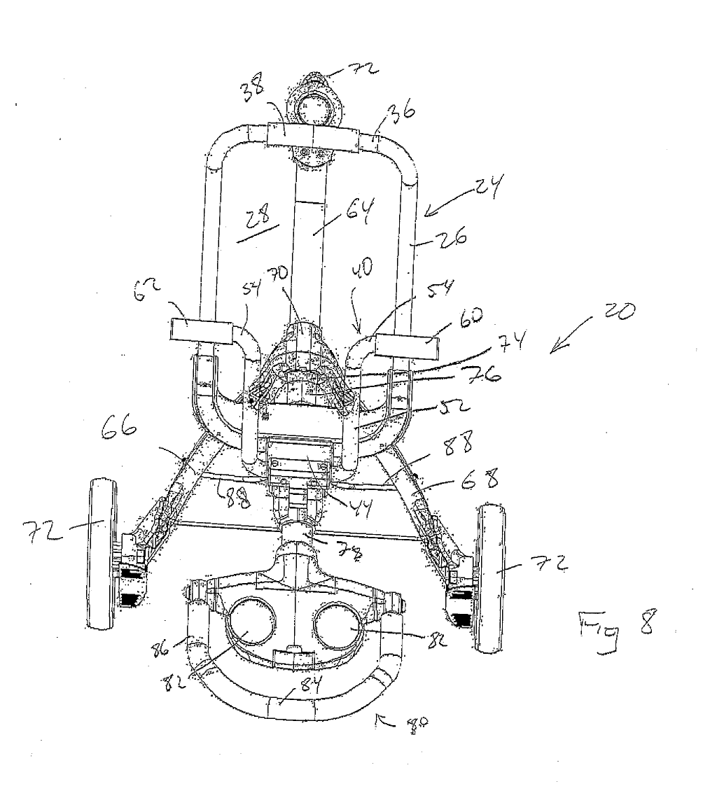

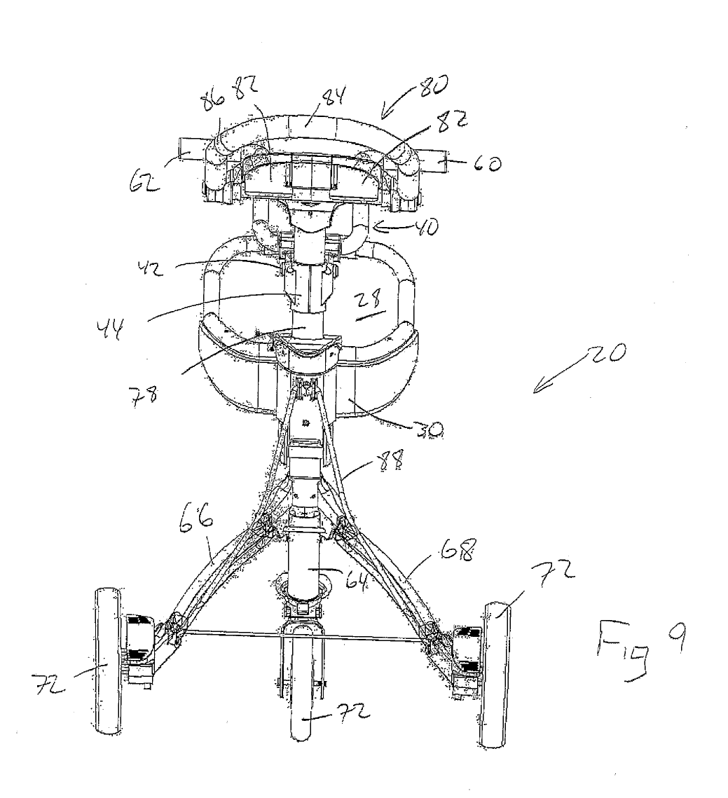

With respect to the shape of the roll bar 40, as shown best in FIGS. 7, 8 and 9, the roll bar includes first and second arms 46 and 48 which extend from a central shaft 50. More specifically, extending directly from the shaft 50 at perpendicular angles are first sections 52 of the arms 46 and 48, and then again at right angles, second sections 54 extend from the first sections 52. In so doing, the toll bar 40 is able to engage sides 56 and 58 of the infant carrier 22 without actually engaging the child therein or even infringing upon the space for movement of the child within the infant carrier 22. The second sections 54 may further include paddings 60 and 62 to again allow for a certain degree of shock absorption of the infant carrier 22 as the transport 20 is traversed across a surface, while also affording a certain degree of improved functional grip between the roll bar 40 and the infant carrier 22.

With respect to the frame 32 of the universal infant carrier transport 20, it is depicted as a tripod arrangement very reminiscent of carts used to transport golf clubs about a golf course or the like. In addition, the frame 32 is configured so as to be easily folded into a much smaller configuration for easy storage in a closet or transport within an automobile trunk for example.

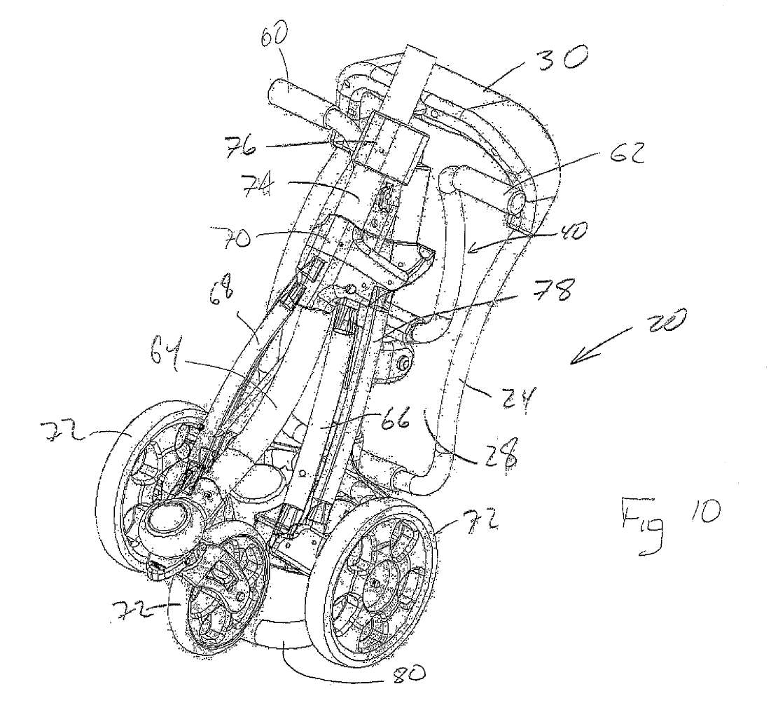

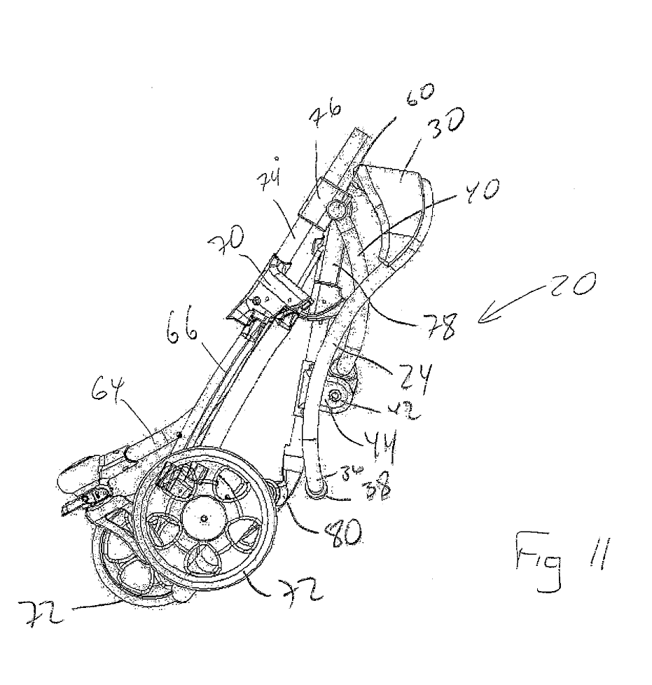

Referring again to FIG. 1, the frame 32 is shown to include first, second and third legs 64, 66 and 68 extending from a T-joint 70. Each of the legs 64, 66 and 68 terminate with a wheel 72 being pivotally mounted thereto. The front leg 64 fixedly extends from the t-joint 70, while the two side legs 66 and 68 are pivotally mounted to the T-joint 70. Accordingly, as can be seen from a comparison between any of FIGS. 1-9 with those of FIGS. 10 and 11, when the transport 20 is to be stored, the frame 32 can be broken down into the folded configuration wherein the side legs 66 and 68 are folded toward the front leg 64 to a substantially parallel orientation thereto. Any number of structures can be used to secure the side legs 66 and 68 into the extended or deployed configuration of FIGS. 1-9 and allow for release thereof to pivot the legs into the folded configuration of FIGS. 10 and 11. For example, the legs 66 and 68 can be simply pivoted to the T-joint with hinges and provided with clasps to hold the legs into position. The clasps can be separate elements which wrap around the legs to hold them into position or could be provided in the form of detents which are adapted to move into recesses in the T-joint, with the T-joint itself having a certain degree of deflection to allow for such movement. Those of ordinary skill in the art will readily recognize many other mechanisms and structures which would allow for such pivotal movement, all of which are encompassed by the scope of the present invention.

Extending upwardly from the T-joint 70 is a spine 74. As will be readily noted, it is from the spine 74 that the platform 24 and roll bar 40 specifically extend. A coupling 76 is mounted on the spine 74 with a neck 78 being pivotally mounted to the coupling 76. As shown best in FIGS. 10 and 11, the coupling 76 allows the neck 78 to be pivoted downwardly relative to the spine 74 and the legs 64, 66 and 68. In so doing, the frame 32 can be configured into a relatively small package when folded thus facilitating storage and transport. As will be described in further detail herein it is to the neck 78 that the ratchet mechanism 44 is mounted and thus from which the toll bar 40 extends.

Referring again to FIGS. 1-6, the neck 78 is shown to terminate in a handle bar assembly 80. The handle bat assembly 80 can be provided in any number of different forms but in the depicted embodiment includes a pair of cup holders 82 with a hand grip 84 extending therefrom for grasping and pushing by the user. The hand grip 84 can be provided with a padded layer 86 for added comfort to the user. Finally, with respect to the frame 32, a reinforcing shaft 88 is shown extending from the spine 74 to the legs 66 and 68. Such reinforcing shafts 80 would be mounted to the spine 74 and legs 66 and 68 in such a way so as to allow for folding of the frame 32 as well.

Turning now to FIGS. 12-14, the ratchet mechanism 44 and its mounting to both the frame 32 and toll bar 40 is shown in more detail. As mentioned earlier, the roll bar 40 functions in much the same way as do the toll bars conventionally used in amusement park rides. As it is desired to have the roll bar be lockable into a plurality of different positions to thus allow for a functional grip of the infant carrier 22 between the roll bat 40 and the platform 24 across a range of infant carrier 22 dimensions and sizes, using such a ratcheting mechanism allows for such dimensional and shape tolerance. In addition, using a ratcheting mechanism 44 provides for added safety in that the roll bat 40 can be moved downwardly from the upward or unlocked position shown in FIG. 1 to the downward or locked position in FIG. 3 or any downward position relative to FIG. 1 and cannot be moved upwardly without the user, i.e., the parent, engaging a release mechanism 90.

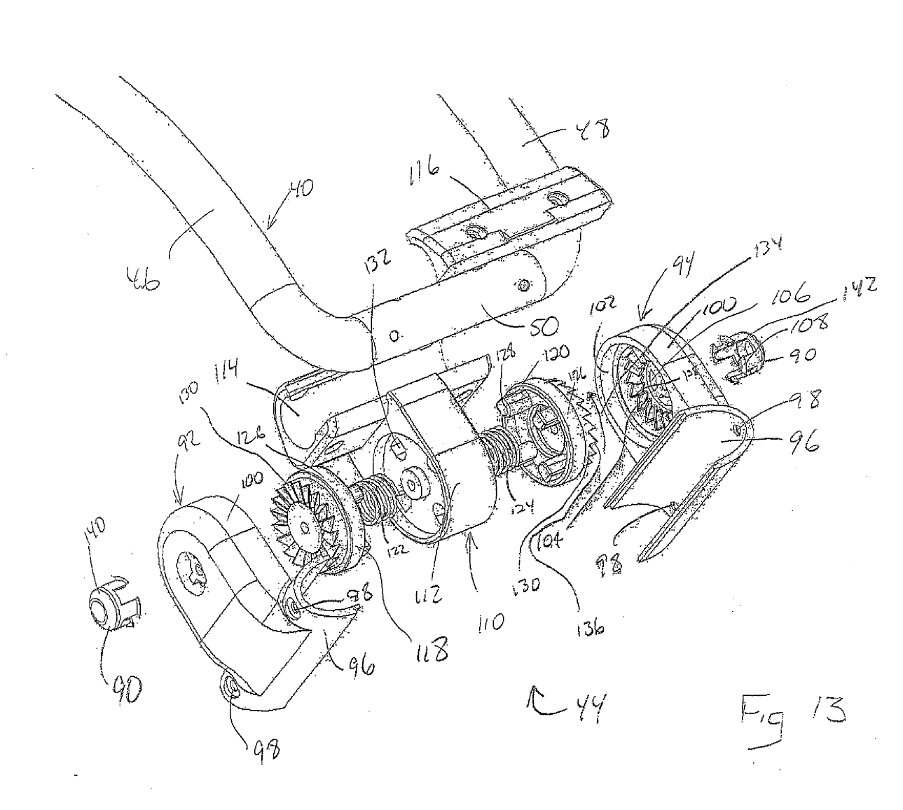

With specific attention to FIG. 13, the ratchet mechanism 44 includes first and second clam shell halves 92 and 94 each of which includes a semi-cylindrical housing 96 to wrap around the neck 78 and be secured together using conventional fasteners (not shown) through apertures 98. Extending from the semi-cylindrical housings 96 are pawl housings 100 including circular recesses 102. Within each circular recess 102 are a plurality of pawl teeth 104 circumscribing apertures 106 which allow for the passage of the legs 108 of the release mechanism 90

The ratchet mechanism 44 further includes a central housing 110 having a mounting disc 112 from which a roll bar grip 114 extends. As is also shown best in FIG. 13, the roll bar grip 114 is a semi-cylindrical recess sized and shaped so as to functionally receive shaft 50 of the roll bar 40. A clamping plate 116 can then be used and along with fasteners (not shown) the loll bar 40 can be secured into the roll bar grip 114 so as to prevent relative rotation therebetween. In other words, when the loll bar 40 is pivoted, the roll bar grip 114 and mounting disc 112 are designed to rotate along with the roll bar 40.

To complete the ratchet mechanism 44, it can be seen that first and second ratchet wheels 118 and 120 are provided along with first and second coil springs 122 and 124. One of the coil springs 122 and 124 is mounted between each ratchet wheel 118 and 120 and the mounting disc 112. With respect to each ratchet wheel 120, it can be seen that each includes a central band 126 from one side of which extend a plurality of appendages 128 and from an opposite side of which extend a plurality of ratchet gear teeth 130. The mounting disc 112 is provided with a corresponding number of apertures 132 to receive the appendages 128 of each ratchet wheel 130. Accordingly, when the roll bar is rotated, not only is the mounting disc 112 also rotated, but so are each of the ratchet wheels 118 and 120.

The springs 122 and 124 are provided to bias each of the ratchet wheels 118 and 120 outwardly away from the mounting disc 112 and into engagement with the plurality of pawl teeth 104 provided on each of the clam shell halves 92 and 94. It is important to also note that the pawl teeth 104 and ratchet teeth 118 do not extend at light angles but lather are provided at acute angles. In so doing, the ratchet mechanism acts as a one-way clutch. More specifically, again referring to FIG. 13, when the roll bar 40 is pushed downwardly towards the locked position of FIG. 3, the ratchet teeth 130 are rotated in the direction represented by arrow 134. Even though the springs 122 and 124 bias the ratchet wheels 118 and 120 toward the clam shell halves 92 and 94, such angling of the ratchet teeth 130 allow for them to rotate past, or out of engagement with, pawl teeth 104 and into the next or adjacent set of pawl teeth 104. In so doing, it can be seen that the roll bar can be rotated downwardly in incremental fashion a distance corresponding to the rotational distance the ratchet teeth 130 rotate past corresponding pawl teeth 104.

An added benefit of angling the ratchet teeth 130 in such a fashion is that when the roll bar 40 is attempted to be rotated in a direction opposite to the arrow 134, ledges 136 of the ratchet teeth 130 engage shoulders 138 of the pawl teeth 104 and prevent such rotation. It is only when the release mechanism 90 is engaged that the upward rotation is allowed. More specifically, the release mechanism 90 is provided in the form of first and second release buttons 140, 142 from which the legs 108 extend. When a user, such as a parent, inwardly depresses both release buttons 140 and 142, such motion causes the legs 108 to push against the ratchet wheels 118 and 120. If sufficient inward pressure is applied, this causes the ratchet wheels 118 and 120 to compress the springs 122 and 124 against the mounting disc 112 thereby causes the ratchet wheel teeth 130 to disengage from the pawl teeth 104. Once disengaged, the ratchet wheels 118 and 120 as well as the mounting disc 112 and most importantly the roll bar 40 can be rotated in the direction of arrow 144 thus allowing the roll bar 40 to be moved from a locked to an unlocked position. Once in the upward, locked position, the infant carrier 22 can be fixedly removed from the transport 20.

From the foregoing, it can be seen that the disclosure provides an easy, safe, and reliable system for transporting infant carriers of all sizes and shapes. As opposed to strollers which have to be specifically manufactured to receive the infant carrier of a specific manufacturer, the disclosed structure allows for practically any currently available infant carrier to be received and safely transported on a wheeled device. Moreover, using a ratcheting roll bar not only allows for safe and reliable retention of a variety of differently sized and shaped infant carriers, but also allows for quick and easy removal of the infant carrier from the transport.

What is claimed is:

1. A universal infant carrier transport, comprising:
a wheeled cart;
a platform extending from the wheeled cart, the platform having a central aperture adapted to receive a bottom surface of an infant carrier; and
a roll bar extending from the wheeled cart and movable between locked and unlocked positions, the roll bar holding the infant carrier between the platform and the roll bar when in the locked position.

2. The universal infant carrier transport of claim 1, wherein the roll bar is mounted to the wheeled cart using a ratchet mechanism.

3. The universal infant carrier transport of claim 2, wherein the ratchet mechanism includes a one-way clutch.

4. The universal infant carrier transport of claim 2, wherein the ratchet mechanism includes a ratchet wheel and a pawl, the ratchet wheel being freely rotatable in a first direction past the pawl, the ratchet wheel being prevented from rotating in a second direction by the pawl.

5. The universal infant carrier transport of claim 4, wherein the ratchet wheel moves in the first direction when the loll bar moves from the unlocked position to the locked position.

6. The universal infant carrier transport of claim 4, further including a release mechanism adapted to disengage the ratchet wheel from the pawl and enable rotation of the ratchet wheel in the second direction.

7. The universal infant carrier transport of claim 1, wherein the roll bar includes first and second arms with a space therebetween, the first and second arms being adapted to engage first and second sides of the infant carrier.

8. The universal infant carrier transport of claim 1, wherein the platform includes a bar forming a closed loop, the closed loop being adapted to circumscribe a bottom of the infant carrier.

9. The universal infant carrier transport of claim 1, wherein the wheeled cart is a tripod having three wheeled legs and an upwardly extending aim from which the platform and the roll bar extend.

10. The universal infant carrier transport of claim 9, further including a handle bar mounted atop the aim, the handle bar including a cup holder.

11. The universal infant carrier transport of claim 9, wherein the tripod is fordable between deployed and folded positions, the three legs being substantially parallel and the arm being folded substantially in half when the tripod is in the folded position.

12. A universal infant carrier transport, comprising:
a wheeled cart;
a platform extending from the wheeled cart;
an infant carrier nesting within the platform, the infant carrier including a handle by which the infant carrier is carried and a bottom by which the infant carrier can be latched into a base strapped into an automobile seat; and
a roll bar adapted to clamp the infant carrier between the platform and the roll bar, the roll bar being lockable in a plurality of positions relative to the platform.

13. The universal infant carrier transport of claim 12, wherein the roll bar is mounted to the wheeled cart using a ratchet mechanism.

14. The universal infant carrier transport of claim 12, wherein the roll bar can be moved downwardly against the infant carrier with the ratchet mechanism allowing such motion, but the toll bar cannot be moved upwardly away from the infant carrier without releasing the ratchet mechanism.

15. The universal infant carrier transport of claim 12, wherein the platform includes a central aperture sufficiently large to receive a bottom of the infant carrier.

16. A universal infant carrier transport, comprising:
a wheeled cart having a frame to which at least one wheel is mounted,
a platform extending from the frame and including an aperture sized to receive a bottom of an infant carriers
a roll bar rotatably mounted to the frame above the platform, the roll bar being rotatably mounted to the frame with a ratchet mechanism, the roll bat being freely movable between an upper, unlocked position to a lower, locked position, the ratchet mechanism preventing movement of the roll bar from the lower locked position to the upper, unlocked position; and
a release mechanism adapted to allow movement of the roll bar from the lower, locked position to the upper, unlocked position.

17. The universal infant carrier transport of claim 16, wherein the roll bar is lockable into a plurality of positions between the upper unlocked position and the lower, locked position.

18. The universal infant carrier transport of claim 16, wherein the ratchet mechanism includes a gear wheel having a plurality of non-radially extending gear teeth and a plurality of non-radially extending pawl teeth, the release mechanism being adapted to move the gear wheel teeth out of engagement with the pawl teeth.

19. The universal infant carrier transport of claim 15, wherein the roll bar includes first and second arms.

20. The universal infant carrier transport of claim 15, wherein the platform, roll bar, and wheeled cart are sized to receive a range of infant carrier sizes and shapes.
